(19) United States
(12) Patent Application Publication
(10) Pub. No.: US 2010/0078235 A1
(43) Pub. Date: Apr. 1, 2010

(54) VEHICULAR POWER GENERATION DEVICE

(76) Inventor: Jimmy Tassin, St. Louis, MO (US)

Correspondence Address: L.C. BEGIN & ASSOCIATES, PLLC, 510 HIGHLAND AVENUE, PMB 403, MILFORD, MI, 48381, US

(21) Appl. No.: 12/557,998

(22) Filed: Sep. 11, 2009

Related U.S. Application Data
(60) Provisional application No. 61/194,859, filed on Oct. 1, 2008.

(51) Int. Cl. B60K 16/00

(52) U.S. Cl. 180/65.31

(57) ABSTRACT

One embodiment of a vehicular power generating device for providing electrical power to the vehicle includes an air channel for ducting air within a vehicular compartment and directs the air towards a housing. The housing includes a rotatably attached wheel that rotates when the directed air comes in contact with vanes of the wheel. The wheel is further attached to a generator that rotates conjointly with the wheel. The generator creates electrical energy, which provides electrical power for producing vehicle's motivational force. The generator also supplies electricity to various electrical components of the vehicle.

### CROSS-REFERENCE TO RELATED APPLICATION

This application claims the benefit of U.S. Provisional Application No. 61/194,859 filed on Oct. 1, 2008 the disclosure of which is incorporated herein by reference.

### FIELD OF THE DISCLOSURE

The present disclosure generally relates to a vehicular power generation device and, more specifically, to a power generation device that utilizes air being displaced by a vehicle.

### BACKGROUND OF THE DISCLOSURE

Automotive vehicles have traditionally been powered by gasoline or diesel fueled engines. However, with the fuel sources for these engines becoming more expensive and the desirability to protect the environment from manmade hazards, other propulsion means are becoming more popular and commercially acceptable. The main propulsion means that are commercially acceptable are traditional gasoline or diesel fueled engines combined with an electric motor, more commonly called “hybrid” vehicles and vehicles that run on only electric power or “electric vehicles”. Both the hybrid and electric vehicles suffer from the same concern: maintaining an electrical charge to power the vehicle accessories and the electric motor or motors that provides the propulsion for the vehicle.

There are known methods for reclaiming the lost energy generated when the vehicle brakes, namely regenerative braking systems. However, these systems lack the ability to recharge the batteries while the vehicle is in steady state motion, such as, while traveling down a highway. This often results in lower fuel efficiency or driving range on a highway than in constant start and stop situations, or city driving.

Additionally, there have been vehicle mounted devices disclosed that capture wind energy as a vehicle proceeds down the road to generate electricity, such as U.S. Pat. Nos. 6,897,575B1 and 5,746,283. However, these references use a fan type propeller system to cause rotation thereby generating electrical power. The fan type propeller needs a large cross sectional area in order to capture the appropriate amount of wind energy to spin the propeller. This is counterproductive as the large amount of air captured causes much drag on the vehicle thereby necessitating additional power to move the vehicle. Furthermore, these devices create much difficulty for the automotive designer to craft a stylish vehicle that would attract the consumer.

Therefore, it remains desirable to have a vehicle power generation device that includes a wind turbine which is shaped with radial protrusions which provides a multitude of vanes to be presented to the air source, a small or no protrusion into the air source, and allows for ducting from high pressure wind areas directly to the wind turbine to generate power.

### SUMMARY OF THE DISCLOSURE

One embodiment of a vehicular power generating device for providing electrical power to the vehicle includes an air channel for ducting air within a vehicular compartment and directs the air towards a housing. The housing provides a rotatably attached wheel that rotates when the directed air comes in contact with vanes of a wheel. The wheel is further attached to a generator that rotates conjointly with the wheel. The generator creates electrical energy, which provides electrical power for producing the vehicle's motivational force. The generator also provides electricity for various electrical components of the vehicle.

### BRIEF DESCRIPTION OF THE DRAWINGS

The following detailed description of preferred embodiments and best mode will be set forth with regard to the accompanying drawings, in which:

FIG. 1 is a perspective view of a power generating device in position within a vehicle, in accordance with an embodiment of the present disclosure;

FIG. 2 is a front view of the power generating device, in accordance with an embodiment of the present disclosure;

FIG. 3 is a section view along the line A-A of FIG. 2 of the power generating device, in accordance with an embodiment of the present disclosure;

FIG. 4 is a perspective view of a vehicle with the power generating device installed in a vehicle while in normal operation, in accordance with an embodiment of the present disclosure;

FIG. 5, is a perspective view of a vehicle with the power generating device installed in a vehicle while in normal operation, in accordance with an embodiment of the present disclosure; and

FIG. 6, is a perspective view of a vehicle with the power generating device shown installed, in accordance with an embodiment of the present disclosure.

Like reference numerals refer to like parts throughout the description of several views of the drawings.

### DETAILED DESCRIPTION OF THE DISCLOSURE

The exemplary embodiments described herein detail for illustrative purposes are subject to many variations in structure and design. It should be emphasized, however, that the present disclosure is not limited to a vehicular power generating device for providing electrical power to a motorized vehicle. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The use of terms, “including,” or “comprising,” and variations thereof herein is meant to encompass the items listed thereafter and equivalents thereof as well as additional items.

The terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item.

Unless limited otherwise, the terms “attached,” “secured,” “disposed,” and variations thereof herein are used broadly and encompass direct and indirect attachments and arrangements. The terms, “top,” “side,” and the like, herein do not denote any order, elevation or importance, but rather are used to distinguish placement of one element over another.

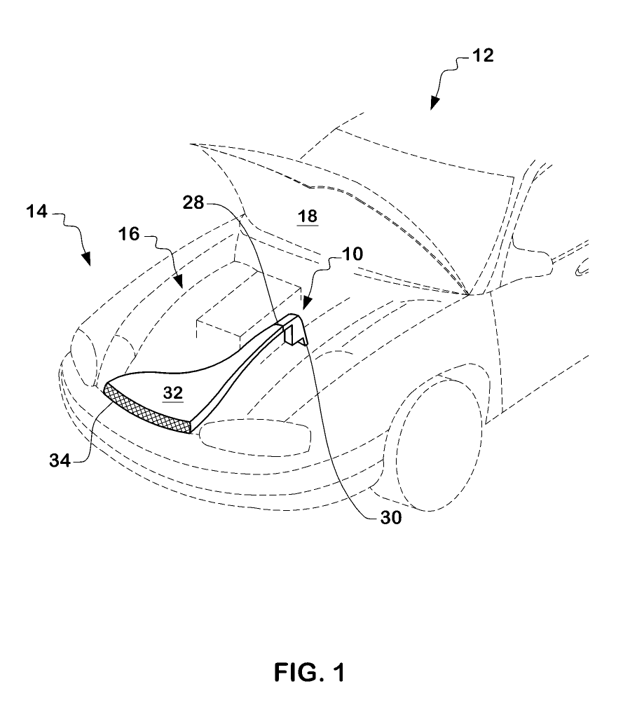

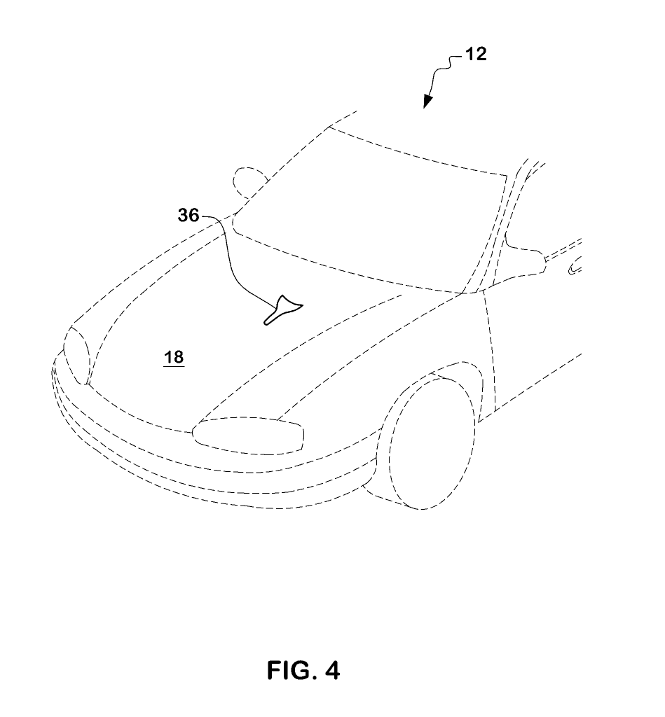

Referring to FIG. 1, a power generating device is shown generally at 10 as installed on a vehicle 12. The vehicle 12 is shown as a conventional four wheel automobile but may be of many configurations, including a three wheel or a two wheel vehicle. The vehicle 12, however, is one that utilizes electric power for at least a portion of its motive force. That is, the vehicle 12 would generally be considered a “hybrid” or an electric vehicle. The vehicle 12 includes a front end 14 which includes a compartment 16 for housing the power generating device 10 as well as other automotive accessories and components that may be required to be packaged therein. Access to the compartment 16 is provided by a hingedly secured hood 18 that moves between a first closed position, as best seen in FIG. 4, and a second open position, as best seen in FIG. 1.

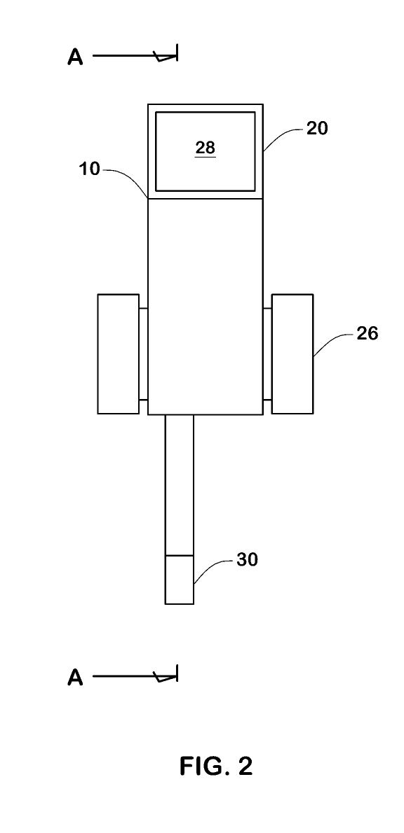

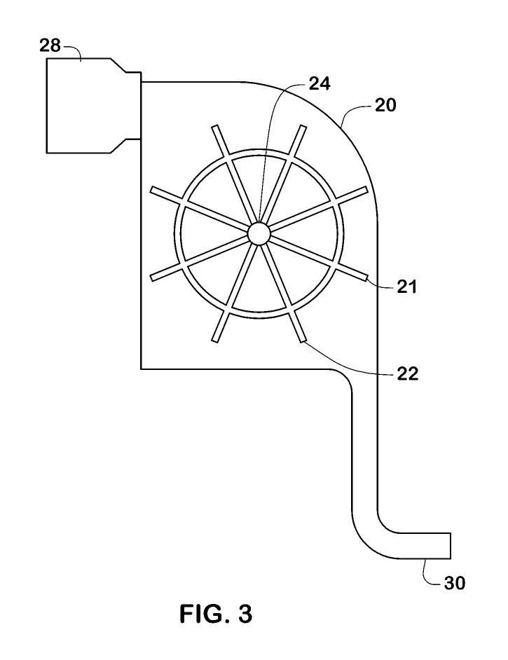

Referring now to FIG. 2, the power generating device 10 includes a housing 20. Section line A-A is disposed through the power generating device 10 and the Section A-A can be seen in FIG. 3, which will now be referred. A wheel 21 is rotatably secured inside the housing 20. The wheel 21 includes a plurality of radial vanes 22 which extend outwardly from a center hub 24. The vanes 22 are shown in a straight surface configuration but may be curved or angled if so desired for efficiencies or packaging. Referring again to FIG. 2, the center hub 24 is rotationally connected to a generator 26 that is used to generate electricity for the vehicle 12. The generator 26 may be internal or external to the housing 20. The housing 20 further includes an inlet 28 and an outlet 30 for providing air an entry and exit, respectfully.

Referring again to FIG. 1, the power generating device 10 is secured within the compartment 16 such that the inlet 28 is facing an efficient direction for receiving air flow from a moving vehicle. Generally, the inlet 28 will be facing in the direction of normal vehicular travel, as depicted, but may be oriented in various directions for packaging and efficiency reasons. The outlet 30, however, is positioned such that any air inside the housing 20 can easily be expelled to the atmosphere. Therefore, the outlet 30 may be positioned toward the bottom or the side of the vehicle 12.

The compartment 16 further includes an air channel 32 for providing direct outside air to the inlet 28. The air channel 32 includes an intake portion 34 that is positioned in the direction of normal vehicular travel, that is, toward the front of the vehicle 12. The air channel 32 generally will act as a funneling device to focus moving air into the inlet 28.

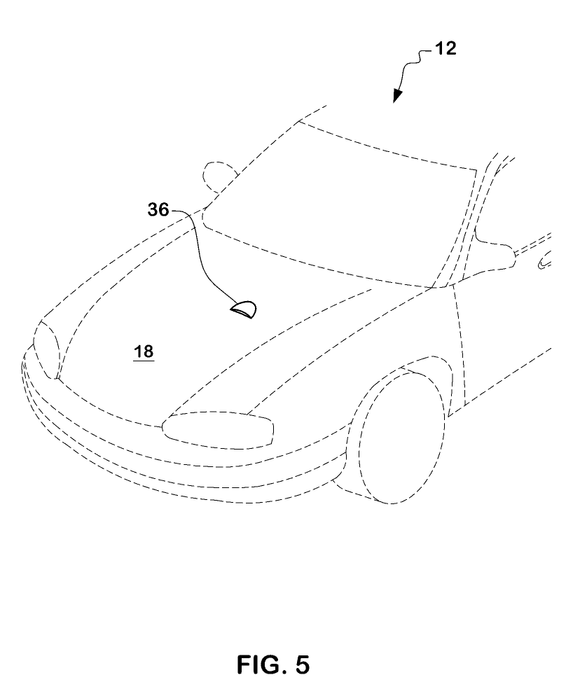

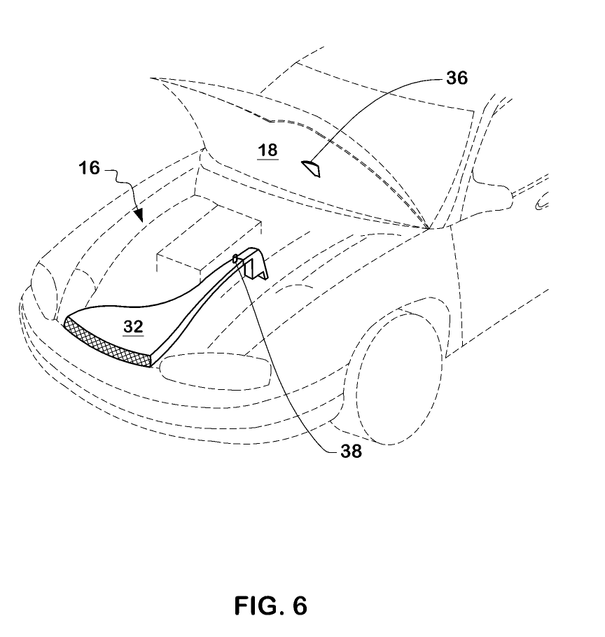

As best seen in FIG. 4, either additionally or alternatively to the air channel 32, the hood 18 may include an aperture 36 at or near the inlet 28 of the power generating device 10. The aperture 36 may be a NACA duct style opening or may protrude above the hood 18 as a hood scoop, as depicted in FIG. 5. If the aperture 36 is in addition to the air channel 32, the air channel 32 includes a duct 38 for accepting the additional incoming air, as is best seen in FIG. 6. If the aperture 36 is in the alternative to the air channel 32, the duct 38 may be directed to the inlet 28 of the housing 20. It should be noted by those having skill in the art that the power generating device is being shown in the front of the vehicle for convenience and it may be positioned in other areas of the vehicle that are conducive to receiving sufficient air flow to motivate the generator.

In operation, a vehicle 12 that uses electric motive power is equipped with the power generating device 10. The vehicle 12 is accelerated causing relative air motion to the vehicle 12. The air channel's 32 intake portion 34 accepts the air and channels the air toward the inlet 28. Additionally or alternatively, air may also be moved from the aperture 36 in the hood 18 toward the inlet 28. The inlet 28 accepts the air into the housing 20 and directs the air over the vanes 22 thereby causing the wheel 21 to spin about the center hub 24. The outlet 30 allows for the air to exit the housing 20 and the vehicle 12. When the wheel 21 begins rotating, the center hub 24 compels the generator 26 to spin which creates electrical power. The electrical power generated is then utilized to run various automotive functions, including the motive forces or other electrical devices. The electrical power may also be stored by various means such as through battery packs or capacitors for later use.

While the forms of the invention herein disclosed constitute presently preferred embodiments, many others are possible. It is not intended herein to mention all the possible equivalent forms or ramifications of the invention. It is understood that the terms used herein are merely descriptive, rather than limiting, and that various changes may be made without departing from the spirit or scope of the invention. For example, without limitations, the duct may provide outside air from various sources outside the vehicle body.

What is claimed is:

1. A vehicular power generating device, comprising:
an air channel;
the air channel connected to a housing;
the housing disposed inside a vehicular compartment; the air channel ducts air into the housing;
a wheel rotatably attached to said housing; the wheel further comprising means for receiving ducted air thereby, creating rotational movement to said wheel; and
a generator interconnected to said wheel whereby, the rotational movement of the wheel induces rotational movement to the generator, thus creating electrical energy.

2. The vehicular power generating device of claim 1, wherein said air channel comprises an intake portion at a front of the vehicle.

3. The vehicular power generating device of claim 1, wherein said air channel comprises a duct for providing air to said housing from an aperture.

4. The vehicular power generating device of claim 1, wherein said wheel comprises a plurality of vanes for accepting the air and causing rotation of said wheel.

5. The vehicular power generating device of claim 1, wherein said generator is located outside of said housing.

6. The vehicular power generating device of claim 1, wherein said generator is located within said housing.

7. The vehicular power generating device of claim 1 wherein the electrical energy provides energy to motivate the vehicle.

8. The vehicular power generating device of claim 1 wherein the electrical energy provides energy to power accessories within the vehicle.

9. The vehicular power generating device of claim 1 wherein the electrical energy provides energy to motivate the vehicle and power the accessories within the vehicle.
